(19) United States
(12) Patent Application Publication
(10) Pub. No.: US 2005/0240471 A1
(43) Pub. Date: Oct. 27, 2005

(54) Use of candy wrap for marketing/advertising of businesses and in combination with Internet

(76) Inventor: Ahmad Pourhamid, Vancouver (SE)

Correspondence Address: JEFFREY FURR, 253 N. MAIN STREET, JOHNSTOWN, OH, 43031, US

(21) Appl. No.: 10/709,232

(22) Filed: Apr. 22, 2004

(51) Int. Cl. G06F 17/60

(52) U.S. Cl. 705/14

(57) ABSTRACT

A method for use of the inside of a candy wrap as a marketing/advertising tool for local businesses. The inside part of the candy wrap will have the information about the business, plus it gives the customer a chance to win a prize either directly or by collecting the wraps or lottery drawing in future dates. The customer can check the possibilities of future winnings/possibilities though visiting the website. The fact that customer can win a prize, will highly increase the chance that customer reads the advertisement. Another important part of this method is the advertisement distribution method that insures right type of customers, in the correct geographical area will receive the advertisement, by selective distribution of advertisement.

### BACKGROUND OF INVENTION

This invention relates to candies as given out by many businesses, for example restaurants and how to convert it to a powerful and cost effective marketing/advertising tool.

While many businesses have been giving out complimentary candies for many years, it hasn't been considered a marketing tool and it is generally considered a cost for generating goodwill. This will be changed with our new method, not only will the candies become a marketing tool but a very effective one since it will target the desired customer group in the correct geographically area of the business. By providing incentives it will motivate the customer to read the advertisement located in the candy wrap.

### SUMMARY OF INVENTION

The current invention is the method of using the complimentary candies that is given out by many businesses to market and advertise the businesses; by placing ads on the inside of the candy wrap and giving out prizes that can be either won instantly or/and by checking the main website for the prize requirements. The name and web site address will be on the outside of all candy wraps. The special distribution method insures that right customers in the correct geographical area of the advertised business be targeted. This is a very targeted marketing system since it targets the customers of the similar businesses in the same geographical area.

### OBJECTS AND ADVANTAGES

Several objects and advantages of the current inventions: 1. Until now complimentary candy was considered a cost, but with this system, it becomes a powerful marketing tool.

2. This marketing system has many advantages, since it advertises the business directly to a targeted customer group. They're already customers of similar businesses geographically located in the same area as the business, which is marketed. The similar businesses or in a sense competitions are the ones who are giving the advertisements out for the advertised business. 3. It insures the targeted customer reads the advertisement since they are motivated to read the text in order to determine if they have won the prize located inside the candy.

4. They will keep the advertisements in order to collect the predefined combination of ads. By collecting these predefined combinations, customers will have a chance to win bigger prizes.

5. The business will get even more exposure when users are checking for winning combinations on the web site. This is web site that has it's address on outside of all the candy wraps, so when customers go to web site, will see the ads for similar businesses.

### BRIEF DESCRIPTION OF DRAWINGS

Without restricting the full scope of this invention, the preferred form of this invention is illustrated in the following drawings:

FIG. 1 is method for production and distribution of candies among businesses;

FIG. 2 describes the customer actions and response to the advertisement; and

FIG. 3 Candy wraps design.

### DETAILED DESCRIPTION

The following description is demonstrative in nature and is not intended to limit the scope of the invention or its application or uses.

There are a number of significant design features and improvements incorporated within the invention.

While this invention can be used in many different businesses here we will describe the implementations and operation of this invention in the restaurant business.

The customer will receive a complimentary candy with his/her bill. The customer opens the candy and reads the print inside the wrap in order to determine if he/she has won a prize. The print inside is the advertisement of other restaurants in the same local area. If a customer has won a prize the customer will be motivated to visit the prizewinning restaurant to take advantage of their winnings. Otherwise the customer will keep the candy wrap so he/she can check the main website for prize requirements. When the customer collects the right amount or combination of candy wraps they'll win the prize that is advertised on the website. At the same time when the customer visits the main website they will be exposed to other local business advertisements.

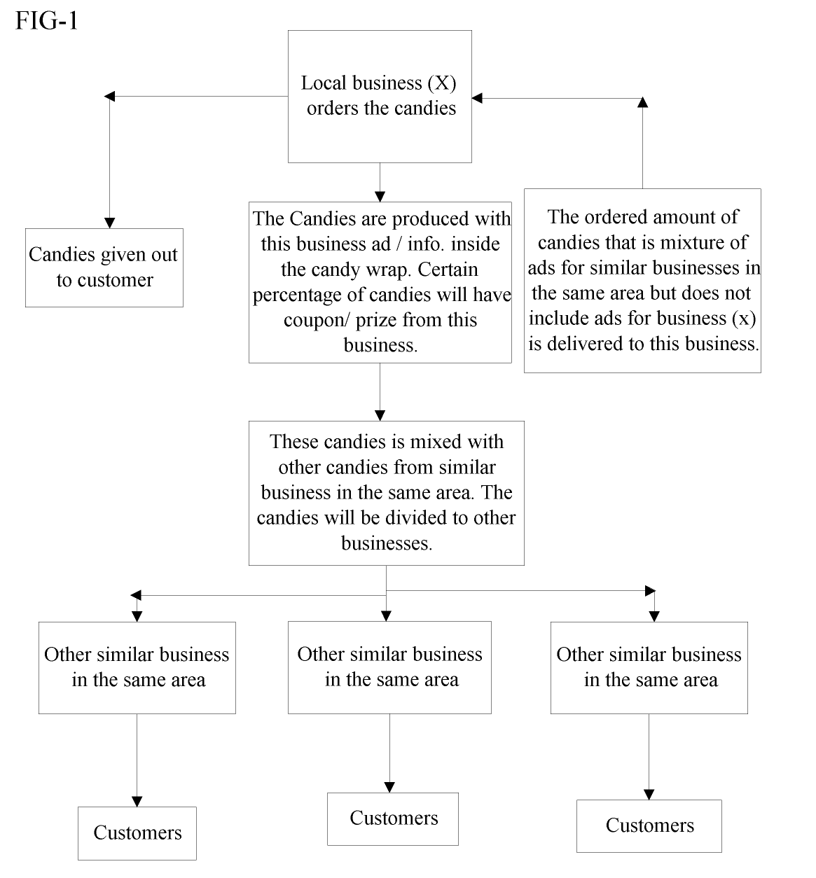

The process is shown in FIG. 1. The local business (X) orders the candies. The candies are produced with the business advertising and information inside the candy wrap with a percentage of candies having coupon/prizes. The business (X) receives a mix of candies from the other similar business in the same geographical area as business (X), while the candies with advertisement for business (X) is distributed to other similar businesses in the area. The business (X) advertises for other local businesses by giving out the candies out to it's customers and other businesses will advertise for business (X) by giving candies out to their clients.

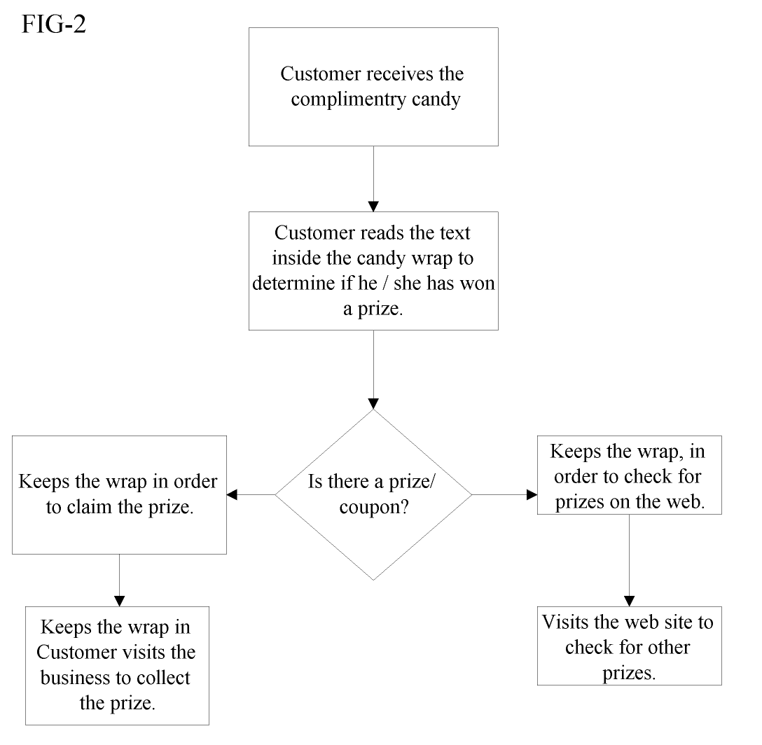

FIG. 2 displays the customer's process. The customer receives the complimentary candy. The customer reads the text inside the candy wrap to determine if they have won a prize. If they win a prize the keep the wrap in order to claim the prize. The customer then visits the business to collect the prize. If they don't win a prize they keep the wrap in order to check for prizes on a website. The customer then visits the website to check for other prizes.

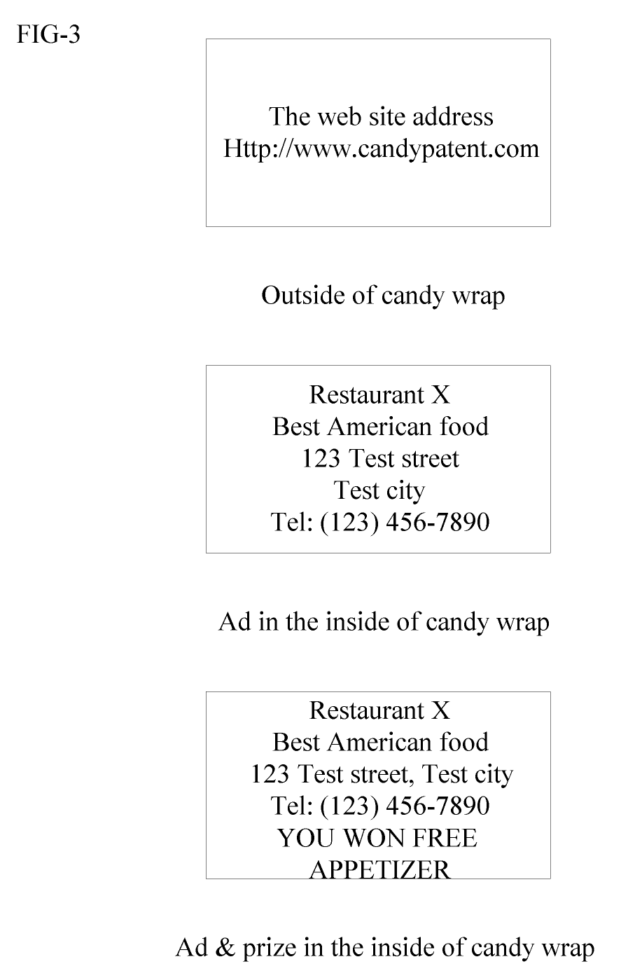

FIG. 3 displays the inside and outside of a proposed candy wrapper. The outside of the candy wrapper has the web site address. The inside of the candy wrapper has an advertisement with or without a prize notification.

Conclusion ramification and scope of invention Thus the reader will see that the above invention provides highly effective targeted yet economical marketing/advertising method. This method will target the exact customer type that is interested in this particular business product. Plus the customer is in the same geographical area as the advertised business. While my above description contains many specifities these should not be constructed as limitations on the scope of invention but rather as an exemplification of one preferred embodiment thereof. Many other variations are possible, for example placing the advertisement on separate media inside the candy wrap or using a series of numbers to have lottery draw for prizes.

Accordingly the scope of the invention should not be determined by the embodiment illustrated but by appended claims and their legal equivalents such as:—To use the candy wraps to deliver a marketing/advertising message—To use the candy wraps as a ticket/coupon for different kind of prizes and drawings.

This method permits a very targeted marketing to customers of similar businesses—This method permits marketing in a very targeted geographically area such as specific part of town that the advertised business is located in; in contrast to other advertising media such as television, radio and newspapers that cover other areas the advertised business has no possibilities of attracting customers.

The customer will keep the ad since it is also ticket/coupon for the prize already won or for the prizes that can be won in the future.

Since customer has to check the website to see the possibility of winning prizes it will continuously keep the customer engaged in the marketing campaign.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Furthermore, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A Method for advertising and marketing of businesses comprising:
Using the of inside a candy wrap for placement of ads, placing web site address (URL) on the outside of candy wrap;
placing a promotion inside the candy wrap;
using of the Internet for marketing and checking the result of promotion in combination with candy wraps; and
using said candy wraps for advertising to specific geographical area and group of customers by using a selection method of distribution to achieve targeted advertisement.

2. A Method according to claim 1 in which said promotion is a discount.

3. A Method according to claim 1 in which said promotion is a prize coupon.

4. A Method according to claim 1 in which said promotion is a lottery number.

5. A Method according to claim 1 in which said customer goes to a website to check a promotion.

6. A candy wrapper comprising:
one side having a web site address and another side having an advertisement and a prize notification.

7. A candy wrapper according to claim 6 further comprising:
Said web site address being on the outside side of said candy wrapper and said advertisement and prize notification being the inside side of said candy wrapper.

8. A method where multiple businesses use the candy wrappers of claim 6.

9. A Method for advertising and marketing of businesses comprising:
Using the of inside a candy wrap for placement of ads, placing web site address (URL) on the outside of candy wrap;
placing a promotion inside the candy wrap;
using of the Internet for marketing and checking the result of promotion in combination with candy wraps;
using said candy wraps for advertising to specific geographical area and group of customers by using a selection method of distribution to achieve targeted advertisement;
wrapping candy wrappers around candy;
mixing candy from a select group of businesses; and
having businesses distribute the mixed candy.

10. A Method according to claim 9 in which said promotion is a discount.

11. A Method according to claim 9 in which said promotion is a prize coupon.

12. A Method according to claim 9 in which said promotion is a lottery number.

13. A Method according to claim 9 in which said customer goes to a website to check a promotion.

14. A Method according to claim 9 in which said distribution method is giving it free to said customers.
